(19) United States
(12) Patent Application Publication
(10) Pub. No.: US 2023/0295022 A1
(43) Pub. Date: Sep. 21, 2023

(54) SAMPLING DEVICE FOR COAGULATION TREATMENT DEVICE, COAGULATION TREATMENT DEVICE, AND WATER TREATMENT METHOD

(71) Applicant: KURITA WATER INDUSTRIES LTD., Tokyo (JP)

(72) Inventors: Naoya KAWARABAYASHI, Tokyo (JP); Yutaka KAYAMORI, Tokyo (JP)

(73) Assignee: KURITA WATER INDUSTRIES LTD., Tokyo (JP)

(21) Appl. No.: 18/020,613

(22) PCT Filed: Mar. 18, 2021
(86) PCT No.: PCT/JP2021/011028

§ 371 Date: Feb. 9, 2023

(30) Foreign Application Priority Data
Aug. 12, 2020 (JP) 2020-136253

(51) Int. Cl. C02F 1/52; C02F 1/24; B01D 21/30; B01D 21/01; B01D 21/00

(52) U.S. Cl. CPC C02F 1/5209; C02F 1/5281; C02F 1/24; B01D 21/305; B01D 21/302; B01D 21/01; B01D 21/0084; C02F 2209/001; C02F 2209/44

(57) ABSTRACT

This sampling device for a coagulation treatment device (1) comprises at least: a sealed-type coagulation reaction tank to which is introduced water to be treated to which a flocculant has been added; and a solid-liquid separation tank to which is introduced the water to be treated that has been drawn from the coagulation reaction tank, the sampling device comprising a sampling tank, a coagulation sensor installed inside the sampling tank, and a water sending pipe (43) which sends, from the coagulation reaction tank of the coagulation treatment device to the sampling tank, a part of the water to be treated inside the coagulation reaction tank.

### TECHNICAL FIELD

The present invention relates to a sampling device for a coagulation treatment device, a coagulation treatment device, and a water treatment method.

This application is based upon and claims the benefit of priority from Japanese Patent Application No. 2020-136253, filed Aug. 12, 2020, the entire content of which is incorporated herein by reference.

### BACKGROUND ART

In purification treatment of water supplies, industrial water, sewage, drainage, and the like (water quality improvement treatment), for example, coagulation treatment of suspended matter in water to be treated is performed by inputting a flocculant to the water to be treated. Next, flocculation consisting of the coagulated suspended matter is subjected to solid-liquid separation from the water to be treated. Examples of solid-liquid separation techniques include techniques such as precipitation separation, pressurization floatation separation, centrifugal separation, sand filtration, and membrane separation.

For example, Patent Literature 1 discloses, in FIG. 2, as an example of a coagulation treatment device, a coagulation pressurization floatation device in which a coagulation tank, a mixing chamber, and a floating separation chamber are installed in this order and a pressurized water manufacturing device is installed. The pressurized water manufacturing device injects pressurized water into the mixing chamber. In Patent Literature 1, the coagulation tank, the mixing chamber, and the floating separation chamber are isolated from the atmospheric air by a cover. In addition, the pressurized water manufacturing device manufactures pressurized water in which gas is pressurized and dissolved in water, and the pressurized water can be injected into the mixing chamber. In the coagulation pressurization floatation device disclosed in Patent Literature 1, pressurized water having gas pressurized and dissolved therein is injected by the pressurized water manufacturing device into water to be treated which flows inside the mixing chamber and to which a flocculant is added. Gas which has dissolved in the pressurized water adheres to flocculation in the water to be treated. Accordingly, a buoyant force is applied to the flocculation. Flocculation floats to a part near a liquid level of the water to be treated in the floating separation chamber. Accordingly, flocculation is efficiently subjected to floatation separation.

However, in the coagulation pressurization floatation device disclosed in Patent Literature 1, a retention time of water to be treated from the coagulation tank to a solid-liquid separation tank is set to one hour or longer. For this reason, for example, if a turbidity of water to be treated is measured in the floating separation chamber and feedback control of an adding amount of a flocculant is performed based on turbidity measurement results, a delay time becomes nearly one hour. For this reason, the coagulation pressurization floatation device disclosed in Patent Literature 1 may not be able to perform automatic control with favorable responsiveness.

Such a problem of responsiveness is not limited to the coagulation pressurization floatation device in Patent Literature 1, and it is an inherent problem in coagulation treatment devices in the related art.

In addition, for example, Patent Literature 2 discloses a coagulation monitoring device allowing prompt and appropriate understanding of a coagulation state in water to be treated due to a simple device constitution. However, even if such a coagulation monitoring device is used for understanding of the coagulation state in the coagulation pressurization floatation device disclosed in Patent Literature 1 or understanding of the coagulation state of a coagulation treatment device in the related art, it is insufficient to resolve an influence of the delay time, and thus it is difficult to realize automatic control with favorable responsiveness.

In addition, in order to eliminate the influence of the delay time in Patent Literature 1 as much as possible, it is conceivable that the coagulation monitoring device disclosed in Patent Literature 2 be installed on a side closer to the coagulation tank of the floating separation chamber in FIG. 2 of Patent Literature 1, for example. However, in the coagulation monitoring device in Patent Literature 2, there is a limitation that appropriate measurement cannot be performed unless the coagulation state of water to be treated has proceeded to a certain extent due to a measurement principle. In addition, in water to be treated flowing in a flow channel closer to the coagulation tank, coagulation reaction has not proceeded completely, thereby resulting in insufficient formation of flocculation. For this reason, even if the coagulation monitoring device in Patent Literature 2 is disposed near the coagulation tank in Patent Literature 1 to resolve the delay time, there is concern that the adding amount of a flocculant may not be able to be appropriately controlled.

Moreover, in FIG. 2 of Patent Literature 1, a sealed-type coagulation tank is realized by attaching a cover to a coagulation tank. In addition, in the related art, there are cases in which a sealed-type coagulation tank utilizing a piping or the like is installed. It is difficult to provide an installation space for a coagulation monitoring device in such a sealed-type coagulation tank.

### CITATION LIST

### Patent Literature

### [Patent Literature 1]

Japanese Patent Laid-Open No. 2009-119338

### [Patent Literature 2]

Japanese Patent No. 4605327

### SUMMARY OF INVENTION

### Technical Problem

The present invention has been made in consideration of the foregoing circumstances, and an object thereof is to provide a sampling device for a coagulation treatment device, a coagulation treatment device, and a water treatment method capable of improving responsiveness of addition control of a flocculant in the coagulation treatment device.

### Solution to Problem

[1] A sampling device for a coagulation treatment device includes at least a sealed-type coagulation reaction tank into which water to be treated having a flocculant added thereto is introduced, and a solid-liquid separation tank into which the water to be treated drawn from the coagulation reaction tank is introduced. The sampling device for a coagulation treatment device includes a sampling tank, a coagulation sensor which is installed inside the sampling tank, and a water sending pipe which sends a part of the water to be treated inside the coagulation reaction tank from the coagulation reaction tank of the coagulation treatment device to the sampling tank.

[2] In the sampling device for a coagulation treatment device according to [1], the coagulation sensor is disposed below a position at a water level height of the water to be treated expected in the sampling tank and above a position at a height corresponding to half the water level height.

[3] In the sampling device for a coagulation treatment device according to [2], an overflow part determining the water level height is provided inside the sampling tank. The sampling tank is constituted such that water to be treated retained therein overflows the overflow part and is discharged to the outside of the sampling tank.

[4] In the sampling device for a coagulation treatment device according to [3], a water sending amount sent through the water sending pipe, a capacity of the sampling tank, and a drainage amount of the water to be treated from the sampling tank are set such that a retention time of the water to be treated inside the sampling tank is within a range of 1 to 30 minutes.

[5] In the sampling device for a coagulation treatment device according to [3], a drain valve is provided in a lower part of the sampling tank.

[6] A coagulation treatment device includes a sealed-type coagulation reaction tank into which water to be treated having a flocculant added thereto is introduced, a solid-liquid separation tank into which the water to be treated drawn from the coagulation reaction tank is introduced, and the sampling device according to any one of [1] to [5].

[7] The coagulation treatment device according to [6] further includes a flocculant adding device which adds the flocculant to the water to be treated. The flocculant adding device is provided with an adding part which adds the flocculant to the water to be treated, and a control part which controls an adding amount of the flocculant added by the adding part based on measurement results of a coagulation sensor provided in the sampling device.

[8] In the coagulation treatment device according to [6], a mixing chamber and a floating separation chamber are provided in a flowing direction of the water to be treated in this order in the solid-liquid separation tank. The solid-liquid separation tank is further provided with a pressurized water supply part supplying pressurized water having gas pressurized and dissolved therein to the mixing chamber.

[9] A water treatment method includes, when coagulation separation treatment is performed with respect to water to be treated having a flocculant added thereto by introducing the water to be treated into a sealed-type coagulation reaction tank and then introducing the water to be treated drawn from the coagulation reaction tank to a solid-liquid separation tank, a step of sending a part of water to be treated inside the coagulation reaction tank from the coagulation reaction tank toward a sampling tank, a measurement step of measuring a coagulation state of the water to be treated using a coagulation sensor while separating flocculation in the water to be treated inside the sampling tank, and a control step of performing feedback control of an adding amount of a flocculant to the water to be treated based on the coagulation state of water to be treated measured in the measurement step.

[10] In the water treatment method according to [9], the sampling tank is provided with an overflow part determining a water level height. The sampling tank is constituted such that water to be treated retained therein overflows the overflow part and is discharged to the outside. A retention time of the water to be treated inside the sampling tank in the measurement step is adjusted to within a range of 1 to 30 minutes.

### Advantageous Effects of Invention

According to the present invention, it is possible to provide the sampling device for a coagulation treatment device, the coagulation treatment device, and the water treatment method capable of improving responsiveness of addition control of a flocculant in the coagulation treatment device.

### BRIEF DESCRIPTION OF DRAWINGS

FIG. 1 is an explanatory block diagram of a coagulation treatment device according to an embodiment of the present invention.

FIG. 2A is a side schematic view illustrating a sampling device of a first example according to the embodiment of the present invention.

FIG. 2B is a front schematic view illustrating the sampling device of the first example according to the embodiment of the present invention.

FIG. 2C is a planar schematic view illustrating the sampling device of the first example according to the embodiment of the present invention.

FIG. 3A is a perspective schematic view illustrating the sampling device of the first example according to the embodiment of the present invention.

FIG. 3B is an exploded perspective view illustrating the sampling device of the first example according to the embodiment of the present invention.

FIG. 4 is a block diagram illustrating a coagulation monitoring device.

FIG. 5 is a front view illustrating a coagulation sensor provided in the sampling device.

FIG. 6 is a perspective view illustrating a shielding member provided in the coagulation sensor.

FIG. 7 is a schematic view illustrating an example of a coagulation reaction tank provided in the coagulation treatment device according to the embodiment of the present invention.

FIG. 8 is a schematic view illustrating an example of a coagulation treatment device according to the embodiment of the present invention.

FIG. 9A is a side schematic view illustrating a sampling device of a second example according to the embodiment of the present invention.

FIG. 9B is a front schematic view illustrating the sampling device of the second example according to the embodiment of the present invention.

FIG. 9C is a planar schematic view illustrating the sampling device of the second example according to the embodiment of the present invention.

FIG. 9D is a perspective schematic view illustrating the sampling device of the second example according to the embodiment of the present invention.

### DESCRIPTION OF EMBODIMENT

Hereinafter, a sampling device for a coagulation treatment device, a coagulation treatment device, and a water treatment method according to an embodiment of the present invention will be described with reference to the drawings.

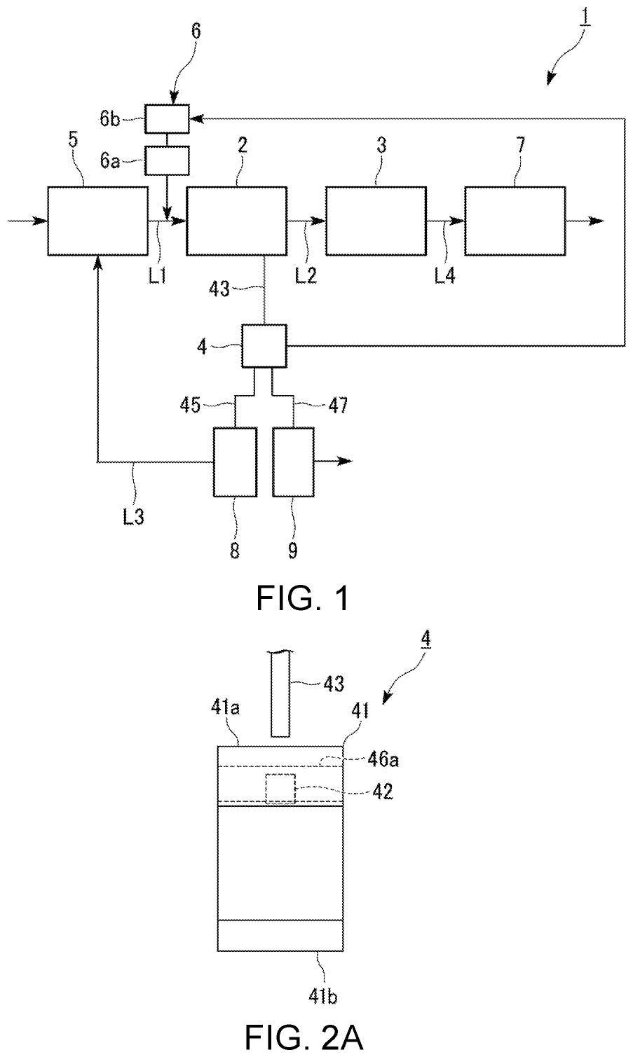

FIG. 1 is an explanatory block diagram of a coagulation treatment device according to an embodiment of the present invention. A coagulation treatment device 1 illustrated in FIG. 1 includes a coagulation reaction tank 2, a solid-liquid separation tank 3, and a sampling device 4. In addition, the coagulation treatment device 1 is provided with a raw water tank 5, a flocculant adding device 6, a treatment tank 7, a water to be treated reception tank 8, and a sludge tank 9. In addition, the sampling device 4 is provided with a water sending pipe 43, a drainage pipe 45, and a drain pipe 47. Hereinafter, details of the coagulation treatment device 1 will be described.

The raw water tank 5 accommodates water to be treated. Examples of water to be treated include tap water, well water, industrial water, and various kinds of drainage.

The flocculant adding device 6 is a device for adding a flocculant to water to be treated. The flocculant adding device 6 is provided with an adding part 6a and a control part 6b. The adding part 6a adds a flocculant to water to be treated. The control part 6b controls an adding amount of a flocculant added by the adding part 6a based on a coagulation state of water to be treated measured by a coagulation sensor which will be described below. As illustrated in FIG. 1, a position of adding a flocculant by the flocculant adding device 6 may be a flow channel L1 connecting the raw water tank 5 and the coagulation reaction tank 2 to each other or may be the coagulation reaction tank 2.

Water to be treated drawn from the raw water tank 5 is introduced into the coagulation reaction tank 2 through the flow channel L1. The coagulation reaction tank 2 allows coagulation reaction to proceed by retaining water to be treated having a flocculant added thereto over a predetermined period of time. As coagulation reaction proceeds, flocculation begins to be formed in the water to be treated.

The coagulation reaction tank 2 may be provided with a stirring device (not illustrated) in order to prompt coagulation reaction. In addition, the coagulation reaction tank 2 of the present embodiment is a sealed type. By making the coagulation reaction tank 2 a sealed type, diffusion of an odor generated in the coagulation reaction tank 2 can be prevented. In addition, the coagulation reaction tank 2 itself can be miniaturized so that an installation space thereof can be reduced.

Water to be treated drawn from the coagulation reaction tank 2 is introduced into the solid-liquid separation tank 3 through a flow channel L2. Flocculation is formed in the water to be treated drawn from the coagulation reaction tank 2. The solid-liquid separation tank 3 performs solid-liquid separation of flocculation and the water to be treated. Regarding specific means for solid-liquid separation, means such as precipitation separation, pressurization floatation separation, centrifugal separation, sand filtration, or membrane separation can be used.

The sampling device 4 is connected to the coagulation reaction tank 2 through the water sending pipe 43. A part of water to be treated inside the coagulation reaction tank 2 is introduced into the sampling device 4 through the water sending pipe 43. Further, the coagulation state of water to be treated is measured in the sampling device 4. The measurement results of the coagulation state from the sampling device 4 are sent to the flocculant adding device 6. The flocculant adding device 6 performs feedback control of the adding amount of a flocculant based on the coagulation state of water to be treated inside the coagulation reaction tank 2. That is, the sampling device 4 provides an input value of feedback control of the adding amount of a flocculant.

The sampling device 4 is provided with the drainage pipe 45 and the drain pipe 47. The drainage pipe 45 is connected to the water to be treated reception tank 8. The drain pipe 47 is connected to the sludge tank 9. The drainage pipe 45 is a flow channel for sending water to be treated discharged from the sampling device 4 to the water to be treated reception tank 8. In addition, the drain pipe 47 is a flow channel for sending flocculation subjected to sedimentation separation from water to be treated in the sampling device 4 to the sludge tank 9 as sludge. More detailed description of the sampling device 4 will be described below.

The water to be treated reception tank 8 is a tank for temporarily storing water to be treated discharged from the sampling device 4. The water to be treated reception tank 8 is connected to the raw water tank 5 through a flow channel L3. Water to be treated stored in the water to be treated reception tank 8 returns to the raw water tank 5 via the flow channel L3.

The sludge tank 9 is a tank for temporarily storing sludge discharged from the sampling device 4. At the point of time when a certain amount of sludge is accumulated in the sludge tank 9, the sludge is collected from the sludge tank 9. The collected sludge is subjected to dehydration treatment, incineration treatment, reclamation treatment, or treatment for reuse of energy.

Water to be treated drawn from the solid-liquid separation tank 3 is introduced into the treatment tank 7 through a flow channel L4. The treatment tank 7 temporarily stores the introduced water to be treated. The water to be treated stored in the treatment tank 7 is supplied to a next use point, supplied to other water treatment means, or discharged to sewerage or public waters.

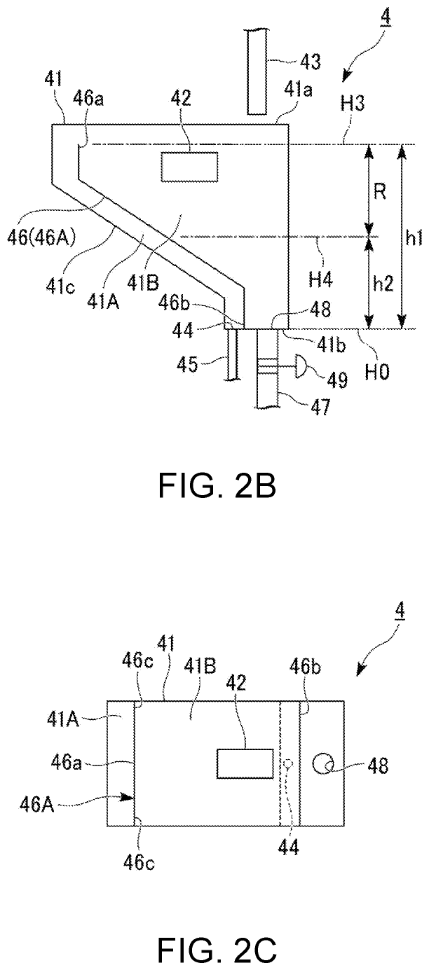

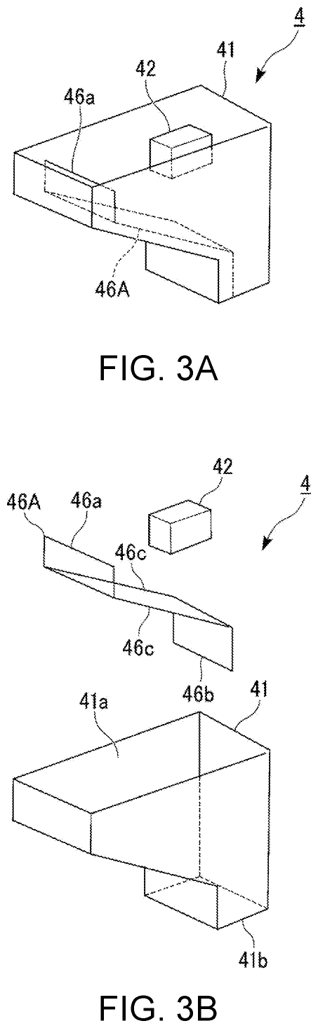

Next, the sampling device 4 of a first example of the present embodiment will be described with reference to FIGS. 2A to 3B.

As illustrated in FIGS. 2A to 3B, the sampling device 4 of the first example is constituted of a sampling tank 41, a coagulation sensor 42 installed inside the sampling tank 41, and the water sending pipe 43 for sending water to be treated from the coagulation reaction tank 2 to the sampling tank 41. In this sampling device 4, the coagulation state of water to be treated sent from the coagulation reaction tank 2 to the sampling tank 41 is measured by the coagulation sensor 42. Hereinafter, details of the sampling device 4 will be described.

The sampling tank 41 is a tank having an open upper part 41a. Water to be treated is introduced into the sampling tank 41 through the water sending pipe 43 disposed thereabove. As illustrated in FIGS. 2A to 3B, the shape of the sampling tank 41 is a shape in which an open area gradually narrows from the upper part 41a toward a bottom part 41b. Such a shape in which an open area gradually narrows is realized by providing an inclined wall surface 41c in the sampling tank 41. Accordingly, when flocculation in water to be treated sediments and gathers at the bottom part 41b of the sampling tank 41, the flocculation is likely to be accumulated as sludge, and thus treatment of the flocculation can be easily performed.

The sampling tank 41 is provided with an overflow part 46 therein. The overflow part 46 illustrated in FIGS. 2A to 2C is constituted by a partition plate 46A installed inside the sampling tank 41. In the partition plate 46A, an upper end 46a is positioned on the upper part 41a side of the sampling tank 41. In addition, the upper end 46a of the partition plate 46A is at a position lower than the upper part 41a of the sampling tank 41. Moreover, a lower end 46b is joined to the bottom part 41b of the sampling tank 41. Moreover, both ends 46c of the partition plate 46A in a width direction are joined to a side surface of the sampling tank 41. Due to such a constitution, the sampling tank 41 is defined into a drainage channel 41A and a retention part 41B by the partition plate 46A. The drainage channel 41A extends from the upper part 41a of the sampling tank 41 toward the bottom part 41b along the inclined wall surface 41c of the sampling tank 41. In addition, the water sending pipe 43 is disposed above the retention part 41B.

Since the water sending pipe 43 is disposed above the retention part 41B, water to be treated sent from the coagulation reaction tank 2 through the water sending pipe 43 is temporarily stored in the retention part 41B. When water to be treated is continuously supplied even though the retention part 41B is completely filled with water to be treated, the overflowed water to be treated flows into the drainage channel 41A over the upper end 46a of the partition plate 46A at a position lower than the upper part 41a of the sampling tank 41 (the water to be treated overflows).

A drainage port 44 and a drain port 48 are provided in the bottom part 41b of the sampling tank 41. The drainage port 44 and the drain port 48 are blocked by the partition plate 46A. Accordingly, the drainage port 44 communicates with the drainage channel 41A of the sampling tank 41. In addition, the drain port 48 is constituted to communicate with the retention part 41B of the sampling tank 41.

The drainage pipe 45 is connected to the drainage port 44. The drainage pipe 45 is connected to the water to be treated reception tank 8. In addition, the drain pipe 47 is connected to the drain port 48. The drain pipe 47 is connected to the sludge tank 9. A drain valve 49 is provided in a middle portion of the drain pipe 47. The drain valve 49 is closed in an ordinary operation state and is opened in order to discharge sludge when sludge gathers at a bottom part of the retention part 41B.

In the sampling device 4 of the present embodiment, it is preferable to set a water sending amount of water to be treated sent through the water sending pipe 43, a capacity of the retention part 41B, and a drainage amount from the drainage port 44 such that a retention time of water to be treated inside the retention part 41B of the sampling tank 41 is within a range of 1 to 30 minutes. Accordingly, a flow of water to be treated inside the retention part 41B is made stable, and thus measurement of the coagulation state of water to be treated is accurately performed by the coagulation sensor 42. The flow of water to be treated inside the retention part 41B can be made stabler by setting the retention time to one minute or longer. In addition, replacement of water to be treated in the retention part 41B proceeds relatively fast by setting the retention time to be within 30 minutes. Accordingly, it is possible to sensitively understand change in coagulation state of water to be treated inside the coagulation reaction tank 2. Further, responsiveness of addition control of a flocculant in the coagulation treatment device 1 can be further improved.

In addition, it is preferable to set a flow rate per unit length of a width of the overflow part 46 of the sampling tank 41 (V÷x (m²/hr), when the length of the width of the overflow part 46 is x (m) and the drainage amount from the drainage port 44 is V (m³/hr)) to 0.2 to 7.0 m²/hr. Accordingly, most of flocculation in water to be treated can be caused to overflow the partition plate 46A (overflow part 46) together with water to be treated and discharged to the drainage channel 41A as scum. Accordingly, an accumulation rate of flocculation in the retention part 41B can be relatively reduced, and thus measurement of the coagulation state of water to be treated can be stably performed. The drainage amount from the drainage port 44 may be adjusted by adjusting a supply amount of water to be treated through the water sending pipe 43.

Next, the coagulation sensor 42 will be described. The coagulation sensor 42 is disposed in the retention part 41B of the sampling tank 41. As illustrated in FIG. 2B, it is preferable that the coagulation sensor 42 be disposed below a position H3 at the water level height of water to be treated expected in the sampling tank 41 and above a position H4 at a height corresponding to half the water level height. In other words, as illustrated in FIG. 2B, the coagulation sensor 42 is disposed within a region R between the position H3 at the water level height and the position H4 at the height corresponding to half the water level height.

The position H3 at the water level height of water to be treated indicates a position at a water level height h1 of water to be treated expected in the sampling tank 41 when a position H0 of the bottom part 41b of the sampling tank 41 is regarded as a reference. This position H3 corresponds to the position of the upper end 46a of the partition plate 46A constituting the overflow part 46. If water to be treated is continuously supplied to the retention part 41B, it overflows the upper end 46a of the partition plate 46A. Therefore, the position H3 at the water level height h1 of water to be treated expected in the sampling tank 41 is determined depending on the position of the upper end 46a of the partition plate 46A.

In addition, the position H4 at the height corresponding to half the water level height indicates a position at a height h2 corresponding to half the water level height h1 when the position H0 of the bottom part 41b of the sampling tank 41 is regarded as a reference.

The region R having the coagulation sensor 42 installed therein is a region corresponding to an upper part of the retention part 41B of the sampling tank 41. The region R becomes a region having a relatively low concentration of flocculation included in water to be treated. That is, since flocculation having a relatively small sedimentation rate is relatively coarse and also has a low density, it overflows the partition plate 46A and is discharged to the drainage channel 41A as scum in an early stage. For this reason, in the region R having the coagulation sensor 42 installed therein, there is a small amount of coarse flocculation which may hinder measurement of the coagulation sensor 42. The coagulation state of water to be treated can be appropriately measured by disposing the coagulation sensor 42 within a range of such a region R.

The measurement results of the coagulation state of water to be treated measured by the coagulation sensor 42 are sent to the control part 6b of the flocculant adding device 6. Further, the measurement results sent to the control part 6b are utilized for feedback control of the adding amount of a flocculant.

The coagulation sensor 42 is not particularly limited as long as it is a light transmission type. For example, it is preferably a type in which water to be treated is irradiated with laser light, scattered light caused by particles included in the water to be treated is received, and a turbidity of the water to be treated is detected.

Regarding a coagulation state measurement device including the coagulation sensor 42, for example, a coagulation monitoring device 100 described below is used.

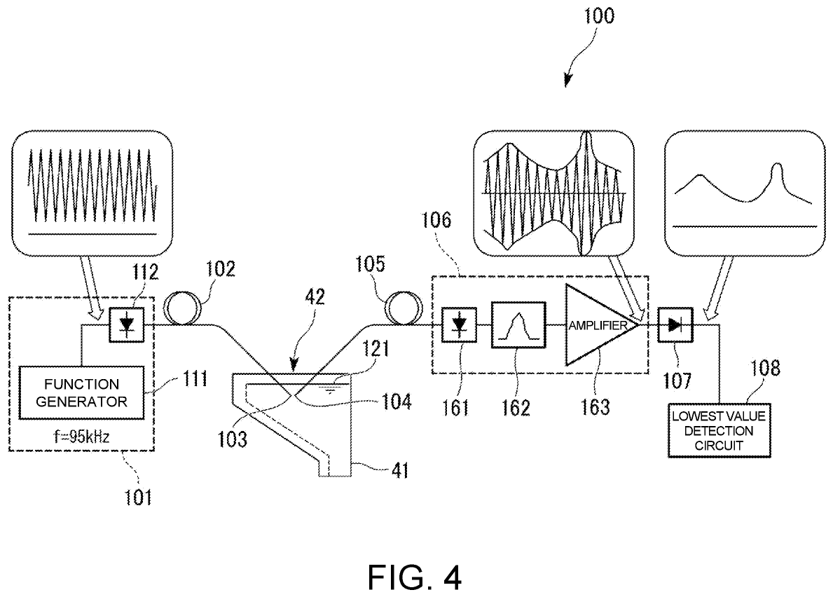

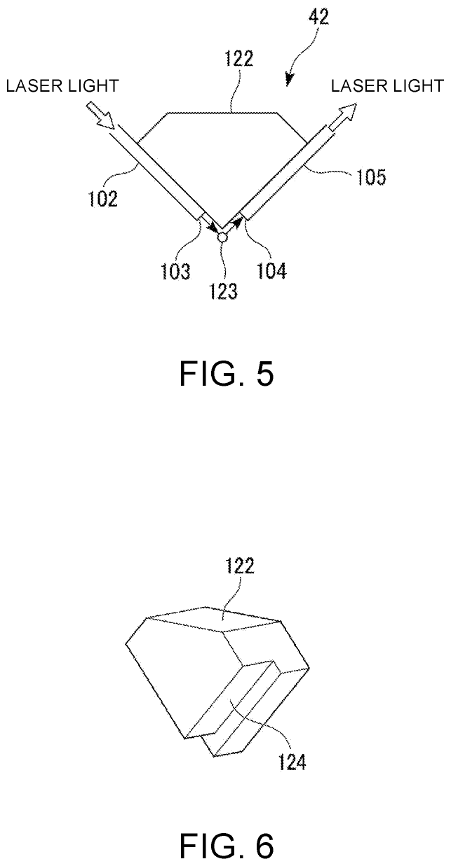

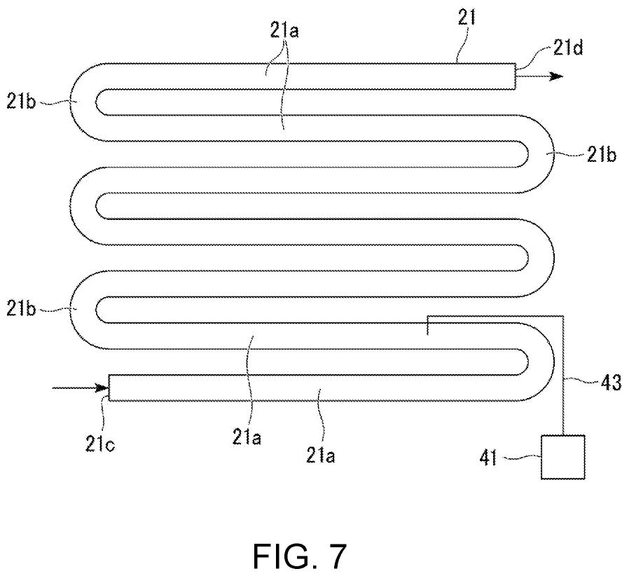

FIG. 4 is a constitution diagram illustrating a schematic constitution of the coagulation monitoring device 100 used in the present embodiment. In addition, FIG. 5 is an enlarged view illustrating a constitution of a laser light irradiation part and a scattered light reception part of the coagulation monitoring device 100 illustrated in FIG. 4. FIG. 6 is an enlarged view illustrating a constitution of a shielding member of the coagulation monitoring device 100 illustrated in FIG. 4.

As illustrated in FIG. 4, the coagulation monitoring device 100 includes a laser oscillator 101, a first optical fiber 102, a laser light irradiation part 103, a scattered light reception part 104, a second optical fiber 105, a photoelectric conversion circuit 106, a detector circuit 107, and a lowest value detection circuit 108.

The laser light irradiation part 103 and the scattered light reception part 104 are input to water to be treated 121 inside the sampling tank 41. As illustrated in FIG. 5, the laser light irradiation part 103 and the scattered light reception part 104 are arranged at a bottom part of a shielding member 122. The shielding member 122 shields a measurement region 123 between the laser light irradiation part 103 and the scattered light reception part 104 from natural light arriving thereat from above.

As illustrated in FIG. 6, the shielding member 122 is a member having a pentagonal prism shape of which a bottom surface protrudes downward and in which groove parts 124 are formed on both protruding side surfaces. The first optical fiber 102 and the second optical fiber 105 are fixed to the groove parts 124. In FIG. 5, the laser light irradiation part 103 that is one end of the first optical fiber 102 and the scattered light reception part 104 that is one end of the second optical fiber 105 are arranged in a bilaterally symmetrical (line-symmetrical) manner. Moreover, it is preferable that an optical axis of the laser light irradiation part 103 of the first optical fiber 102 and an optical axis of the scattered light reception part 104 of the second optical fiber 105 intersect each other at 90 degrees.

The coagulation sensor 42 is constituted of the laser light irradiation part 103, the scattered light reception part 104, and the shielding member 122.

Generally, it is preferable that the intensity of laser light oscillated from the laser oscillator 101 be modulated so as to be distinguished from natural light. In order to return the intensity of scattered light received by the photoelectric conversion circuit 106 to an original electrical signal, the intensity of laser light oscillated from the laser oscillator 101 is preferably subjected to modulation at approximately 70 kHz to 150 kHz. Here, in the constitution of the present embodiment, the laser oscillator 101 is constituted of a function generator 111 and a laser diode 112 and emits laser light, which has been subjected to amplitude modulation (AM) with an electrical signal generated from the function generator 111 and having a predetermined frequency, for example, 95 kHz, from the laser diode 112 to one end of the first optical fiber 102. This laser light is emitted into water to be treated from the other end of the optical fiber 102 serving as the laser light irradiation part 103 via the first optical fiber 102. The laser oscillator 101 is not limited to an oscillator constituted of the function generator 111 and the laser diode 112. For example, a light emitting diode or the like can also be used.

In addition to flocculation, micro colloidal particles (uncoagulated colloidal particles) are present in the water to be treated 121. The laser light used for irradiating micro colloidal particles in the treated water 121 from the laser light irradiation part 103 scatters, becomes scattered light, and is incident on the second optical fiber 105 from one end of the second optical fiber 105 serving as the scattered light reception part 104. In the present embodiment, the measurement region 123 for micro colloid is a region in which a region irradiated with laser light emitted from the laser light irradiation part 103 and a region having the scattered light reception part 104 capable of receiving scattered light overlap each other. The scattered light reception part 104 receives scattered light which has scattered in a direction of 90 degrees (centerline of the second optical fiber 105) from the measurement region 123.

The photoelectric conversion circuit 106 is constituted of a photodetector 161, a bandpass filter 162, and an amplifier 163.

The photodetector 161 is connected to the other end of the second optical fiber 105 and converts an optical signal of scattered light incident on the second optical fiber 105 into an electrical signal.

For distinguishment from natural light, the bandpass filter 162 filters a signal of a modulation frequency component from an electrical signal converted from an optical signal by the photodetector 161.

The amplifier 163 amplifies a signal of a modulation frequency component filtered by the bandpass filter 162 and outputs it to the detector circuit 107.

The photoelectric conversion circuit 106 is not limited to the foregoing constitution as long as an optical signal is converted into an electrical signal. Regarding the photoelectric conversion circuit 106, for example, a photodiode may be used in place of a photodetector, or a low-pass filter may be used in place of a bandpass filter.

Regarding a signal of a modulation frequency component, in order to measure change in intensity of scattered light, AM detection is performed by the detector circuit 107, and a signal after detection thereof is output to the lowest value detection circuit 108. A signal output by the detector circuit 107 is subjected to signal treatment equivalent to that for a signal passing through the low-pass filter. Therefore, by suitably selecting a cut-off frequency of the bandpass filter 162, the detector circuit 107 can perform detection for a signal of an output waveform of a DC component from which fluctuation in this cut-off frequency is eliminated and can output it to the lowest value detection circuit 108. In this manner, in optical signals detected by the photodetector 161, an optical signal after filtration of a modulation frequency component by the bandpass filter 162 and amplification by the amplifier 163 is subjected to AM detection, and thus change in light intensity according to scattering of micro colloidal particles can be measured as change in signal intensity.

The lowest value detection circuit 108 detects a signal intensity having the lowest value from a signal of a DC component input from the detector circuit 107. This detection of the lowest value indicates measurement of a constricted portion of a waveform in terms of a signal waveform output from the amplifier 163. Portions other than the constricted portion indicate the times when coagulated colloidal particles and uncoagulated micro colloid are present in the measurement region 123. The constricted portion indicates the time when coagulated colloidal particles are out of the measurement region. Therefore, by detecting the lowest value of the signal intensity, the lowest value detection circuit 108 can measure the intensity of scattered light, that is, the number of micro colloidal particles when only micro colloidal particles (uncoagulated colloidal particles) are present. Further, reduction of this lowest value indicates reduction of micro colloidal particles in the measurement region. In addition, increase of the lowest value indicates increase of micro colloidal particles.

In addition, there is no need for the coagulation monitoring device 100 to be separately provided with a special measurement part, and scattered light can be measured by installing the laser light irradiation part 103 attached to the shielding member 122 and the coagulation sensor 42 constituted of the scattered light reception part 104 in the sampling tank 41. For this reason, the coagulation sensor 42 can have a simple device constitution. Moreover, since the coagulation monitoring device 100 has a device constitution which is simple, lightweight, and miniaturized, for example, devices in addition to the coagulation sensor 42 can also be embedded into the control part 6b of the flocculant adding device 6.

Next, a water treatment method of the present embodiment will be described.

In the water treatment method of the present embodiment, water to be treated having a flocculant added thereto is introduced into the sealed-type coagulation reaction tank 2. Next, the water to be treated drawn from the coagulation reaction tank 2 is introduced into the solid-liquid separation tank 3. At this time, in the water treatment method of the present embodiment, a water sending step, a measurement step, and a control step are performed. In the water sending step, when coagulation separation treatment is performed with respect to water to be treated, a part of the water to be treated inside the coagulation reaction tank 2 is sent from the coagulation reaction tank 2 toward the sampling tank 41. In the measurement step, the coagulation state of the water to be treated is measured by the coagulation sensor 42 while separating flocculation in the water to be treated inside the sampling tank 41. In the control step, the adding amount of a flocculant to the water to be treated is subjected to feedback control based on the coagulation state of the water to be treated measured in the measurement step. Hereinafter, the water treatment method will be described with reference to the drawings.

First, with reference to FIG. 1, a coagulation separation treatment method for water to be treated utilizing the coagulation treatment device 1 illustrated in FIG. 1 will be described.

Water to be treated stored in the raw water tank 5 is sent to the coagulation reaction tank 2 via the flow channel L1. When the water to be treated passes through the flow channel L1, a flocculant is added by the flocculant adding device 6. A flocculant is preferably an inorganic flocculant, for example. An iron-based flocculant such as ferric chloride or polyferric sulfate; an aluminum-based flocculant such as aluminum sulfate, aluminum chloride, or polyaluminum chloride; or the like can be used. One kind of these may be used alone, or two or more kinds may be used together. In addition, before or after adding a flocculant, an operation of adjusting the pH of the water to be treated may be performed.

Next, in the coagulation reaction tank 2, water to be treated having a flocculant added thereto is retained for a predetermined period of time. Accordingly, coagulation reaction of a contaminant proceeds inside the coagulation reaction tank 2, and flocculation is formed in the water to be treated.

Next, the water to be treated drawn from the coagulation reaction tank 2 is introduced into the solid-liquid separation tank 3 via the flow channel L2. Further, flocculation and the water to be treated are subjected to solid-liquid separation in the solid-liquid separation tank 3. Regarding a specific example of a solid-liquid separation method, means such as a precipitation separation method, a pressurization floatation separation method, a centrifugal separation method, a sand filtration method, or a membrane separation method can be used. The flocculation which has been subjected to solid-liquid separation in the solid-liquid separation tank 3 is collected as sludge. The collected sludge is further subjected to dehydration treatment, incineration treatment, reclamation treatment, or treatment for reuse of energy.

The water to be treated after being subjected to solid-liquid separation in the solid-liquid separation tank 3 is sent to the treatment tank 7 via the flow channel L4. The introduced water to be treated is temporarily stored in the treatment tank 7. The water to be treated stored in the treatment tank 7 is supplied to a next use point, supplied to other water treatment means, or discharged to sewerage or public waters.

Next, with reference to FIGS. 1 and 2A to 2C, operation of a sampling device provided in the coagulation treatment device 1 illustrated in FIG. 1 will be described.

First, in the water sending step, a part of the water to be treated inside the coagulation reaction tank 2 is sent from the coagulation reaction tank 2 toward the sampling tank 41 through the water sending pipe 43. It is preferable that the water to be treated be continuously sent.

The water to be treated partially collected through the water sending pipe 43 is continuously supplied to the retention part 41B of the sampling tank 41. The retention part 41B gradually becomes full of the water to be treated, and the water to be treated is eventually discharged to the drainage channel 41A over the partition plate 46A. At this time, it is preferable to set the flow rate per unit length of the width of the overflow part 46 of the retention part 41B (V÷x (m²/hr), when the length of the width of the overflow part 46 is x (m) and the drainage amount from the drainage port 44 is V (m³/hr)) to 0.2 to 7.0 m²/hr by adjusting the supply amount of the water to be treated through the water sending pipe 43. Accordingly, most of flocculation in the water to be treated is discharged to the drainage channel 41A over the partition plate 46A together with the water to be treated as scum.

In addition, the water sending amount of the water to be treated sent through the water sending pipe 43, the capacity of the retention part 41B, and the drainage amount from the drainage port 44 are set such that the retention time of the water to be treated inside the retention part 41B is within a range of 1 to 30 minutes. Accordingly, while the flow of the water to be treated inside the retention part 41B is made stable, replacement of the water to be treated in the retention part 41B proceeds relatively fast.

In the measurement step, the coagulation state of the water to be treated retained in the retention part 41B is measured using the coagulation sensor 42. Here, it is preferable that an installation position of the coagulation sensor 42 be disposed in the region R which is a region below the position H3 at the water level height of the water to be treated expected in the sampling tank 41 and above the position H4 at the height corresponding to half the water level height. In the region R, the concentration of flocculation included in the water to be treated becomes relatively low. That is, flocculation of which the sedimentation rate is lower than an overflow rate overflows the partition plate 46A and is discharged to the drainage channel 41A as scum in an early stage.

For this reason, in the region R having the coagulation sensor 42 installed therein, there is a small amount of coarse flocculation which may hinder measurement of the coagulation sensor 42, and thus the coagulation state of the water to be treated can be appropriately measured by the coagulation sensor 42.

Measurement of the coagulation sensor 42 may be performed continuously or may be performed at predetermined intervals.

The measurement results from the coagulation sensor 42 are processed by the coagulation monitoring device 100 and sent to the control part 6b of the flocculant adding device 6. In the control part 6b, as the control step, the adding amount of a flocculant is subjected to feedback control based on the coagulation state of the water to be treated inside the coagulation reaction tank 2. In this manner, the measurement results of the coagulation state of the water to be treated measured by the sampling device 4 are utilized for feedback control of the adding amount of a flocculant.

When the water to be treated is continuously measured by the sampling device 4, the water to be treated which has overflowed the partition plate 46A flows out from the drainage channel 41A to the drainage pipe 45 via the drainage port 44.

The water to be treated is sent to the water to be treated reception tank 8 through the drainage pipe 45. Moreover, it returns to the raw water tank 5.

Moreover, in the retention part 41B of the sampling tank 41, flocculation which has not overflowed from the partition plate 46A is deposited at the bottom part of the retention part 41B and becomes sludge. When sludge is excessively accumulated, an effective volume of the retention part 41B is reduced so that the retention time of the water to be treated is shortened. Here, the drain valve 49 is opened in a stage in which a certain amount of sludge is deposited. Accordingly, sludge can be discharged from the retention part 41B so that the effective volume of the retention part 41B can be recovered. The discharged sludge is sent to the sludge tank 9 through the drain pipe 47.

As described above, according to the sampling device 4 for a coagulation treatment device of the present embodiment, water to be treated is sent from the coagulation reaction tank 2 toward the sampling tank 41 installed outside the sealed-type coagulation reaction tank 2 via the water sending pipe 43, and the coagulation state of the water to be treated is measured by the coagulation sensor 42 installed inside the sampling tank 41. Accordingly, it is possible to understand the coagulation state of the water to be treated at the point of time when the retention time is short before the water to be treated is sent to the solid-liquid separation tank 3. Accordingly, a delay time of feedback control of the adding amount of a flocculant to the water to be treated can be shortened, and thus responsiveness of addition control of a flocculant in the coagulation treatment device 1 can be improved.

In addition, according to the sampling device 4 for a coagulation treatment device of the present embodiment, the coagulation sensor 42 is disposed below the position at the expected water level height and above the position at the height corresponding to half the water level height. Accordingly, the coagulation state can be measured with respect to a supernatant portion of water to be treated after relatively coarse flocculation disturbing measurement of the coagulation state has been discharged, it is possible to appropriately understand the coagulation state, and thus responsiveness of addition control of a flocculant in the coagulation treatment device 1 can be further improved.

Moreover, according to the sampling device 4 for a coagulation treatment device of the present embodiment, the sampling tank 41 can be divided into the drainage channel 41A, which communicates with the drainage port 44, and the retention part 41B by the partition plate 46A (overflow part 46) provided inside the sampling tank 41. Further, scum can be caused to overflow together with water to be treated using the partition plate 46A regulating the water level height and can be discharged from the drainage port 44 via the drainage channel 41A, and thus measurement accuracy of the coagulation sensor 42 can be improved. In addition, regarding drainage by the partition plate 46A, since water to be treated in the vicinity of the water level mainly becomes a discharge target, the flow of the water to be treated inside the sampling tank 41 is made relatively stable. Accordingly, measurement of the coagulation state of water to be treated can be accurately performed by the coagulation sensor 42, and thus responsiveness of addition control of a flocculant in the coagulation treatment device 1 can be further improved.

Furthermore, according to the sampling device 4 for a coagulation treatment device of the present embodiment, the water sending amount sent through the water sending pipe 43, the capacity of the retention part 41B, and the drainage amount from the drainage port 44 are set such that the retention time of water to be treated inside the retention part 41B of the sampling tank 41 is within a range of 1 to 30 minutes. The flow of water to be treated inside the retention part 41B can be made stabler by providing a lower limit for the retention time. Accordingly, measurement of the coagulation state of water to be treated can be accurately performed by the coagulation sensor 42, and thus responsiveness of addition control of a flocculant in the coagulation treatment device 1 can be further improved. In addition, replacement of water to be treated in the retention part 41B proceeds relatively fast by providing an upper limit for the retention time. Accordingly, it is possible to sensitively understand change in coagulation state of water to be treated inside the coagulation reaction tank 2, and thus responsiveness of addition control of a flocculant in the coagulation treatment device 1 can be further improved.

In addition, according to the sampling device 4 for a coagulation treatment device of the present embodiment, the drain valve 49 is provided in a lower part of the retention part 41B. Accordingly, flocculation in water to be treated which has sedimented inside the retention part 41B can be discharged by opening the drain valve 49. For this reason, there is no probability that the retention part 41B will overflow due to flocculation, and thus measurement of the coagulation state of water to be treated can be continuously performed.

Moreover, according to the sampling device 4 for a coagulation treatment device of the present invention, since the flow rate per unit length of the width of the overflow part 46 (V÷x (m²/hr), when the length of the width of the overflow part 46 is x (m) and the drainage amount from the drainage port 44 is V (m³/hr)) is 0.2 to 7.0 m²/hr, most of flocculation in water to be treated can be caused to overflow the partition plate 46A together with the water to be treated and discharged to the drainage channel 41A as scum. Accordingly, the accumulation rate of flocculation in the retention part 41B can be relatively reduced, and thus measurement of the coagulation state of water to be treated can be stably performed.

Next, according to the coagulation treatment device 1 of the present embodiment, since the foregoing sampling device 4 is provided together with the sealed-type coagulation reaction tank 2 and the solid-liquid separation tank 3, responsiveness of addition control of a flocculant in the coagulation treatment device 1 can be improved.

In addition, according to the coagulation treatment device 1 of the present embodiment, the flocculant adding device 6 having the adding part 6a and the control part 6b is further provided. Further, in the control part 6b, the adding amount of a flocculant added by the adding part 6a is controlled based on the measurement results of the coagulation sensor 42 provided in the sampling device 4. Accordingly, responsiveness of addition control of a flocculant in the coagulation treatment device 1 can be improved.

Next, according to the water treatment method of the present embodiment, when coagulation separation treatment is performed with respect to water to be treated, a part of the water to be treated is sent from the coagulation reaction tank 2 to the sampling tank 41. The coagulation state of the water to be treated is measured by the coagulation sensor 42 while separating flocculation in the water to be treated. The adding amount of a flocculant to the water to be treated is subjected to feedback control based on the measured coagulation state of the water to be treated. Therefore, responsiveness of addition control of a flocculant in coagulation separation treatment can be improved.

In addition, according to the water treatment method of the present embodiment, the flow of water to be treated inside the retention part 41B can be made stabler by controlling the retention time of the water to be treated inside the retention part 41B within a range of 1 to 30 minutes. Accordingly, measurement of the coagulation state of water to be treated can be accurately performed, and thus responsiveness of addition control of a flocculant in coagulation separation treatment can be further improved. In addition, replacement of water to be treated in the retention part 41B proceeds relatively fast. Accordingly, it is possible to sensitively understand change in coagulation state of water to be treated at the time of coagulation reaction, and thus responsiveness of addition control of a flocculant in coagulation separation treatment can be further improved.

In addition, according to the water treatment method of the present embodiment, since the flow rate per unit length of the width of the overflow part 46 (V÷x (m²/hr), when the length of the width of the overflow part 46 is x (m) and the drainage amount from the drainage port 44 is V (m³/hr)) is 0.2 to 7.0 m²/hr, most of flocculation in water to be treated can be discharged from the retention part 41B as scum. Accordingly, the accumulation rate of flocculation in the retention part 41B can be relatively reduced, and thus measurement of the coagulation state of water to be treated can be stably performed.

(Example of Coagulation Reaction Tank)

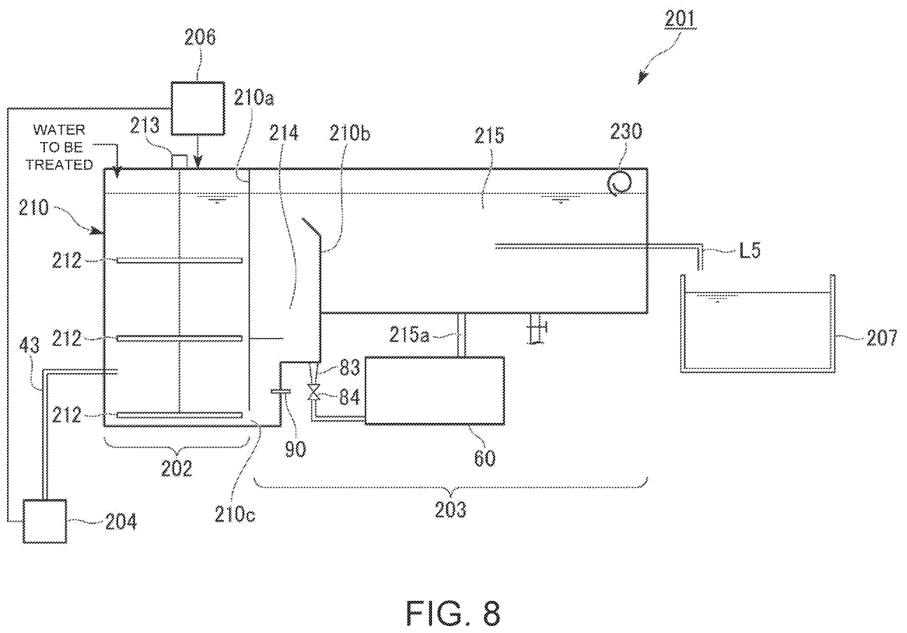

FIG. 7 illustrates an example of a sealed-type coagulation reaction tank. A coagulation reaction tank 21 illustrated in FIG. 7 is constituted of an elongated hollow piping in its entirety, in which a plurality of hollow straight pipes 21a made of a metal or a resin and U-shaped flange pipings 21b are connected to each other. One end of the hollow piping serves as an introduction part 21c of the coagulation reaction tank 21, and the other end thereof serves as a drawing part 21d. In addition, the water sending pipe 43 branches in a middle portion of the coagulation reaction tank 21, and the sampling tank 41 of the sampling device 4 is provided at a tip of the water sending pipe 43.

In this coagulation reaction tank 21, water to be treated having a flocculant added thereto is introduced from the introduction part 21c. Further, coagulation reaction proceeds while water to be treated moves inside the coagulation reaction tank 21. Further, water to be treated in which coagulation reaction has proceeded to a certain extent is drawn from the drawing part 21d and is sent to the solid-liquid separation tank. Since the coagulation reaction tank 21 is constituted of a hollow piping, the inside thereof is sealed with respect to atmospheric air.

Further, a part of water to be treated flowing in the coagulation reaction tank 21 is partially collected through the water sending pipe 43 and sent to the sampling tank 41. The coagulation state thereof is measured by the coagulation sensor installed in the sampling tank 41 and used for feedback control of the adding amount of a flocculant.

According to the coagulation treatment device including the foregoing coagulation reaction tank 21, and the water treatment method utilizing the coagulation treatment device, it is possible to exhibit effects similar to those of the coagulation treatment device 1 illustrated in FIGS. 1 to 6 and the water treatment method using the coagulation treatment device 1.

(Example of Coagulation Treatment Device)

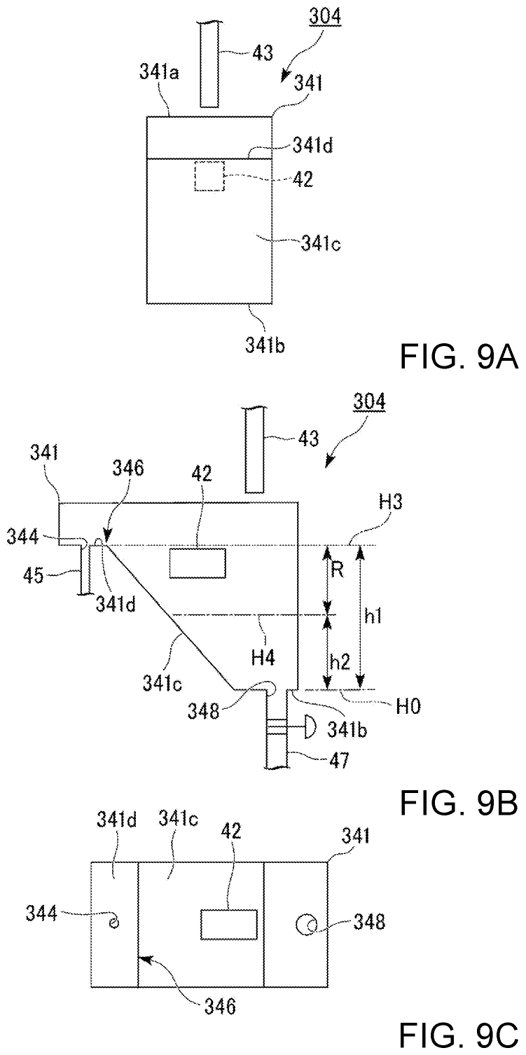

FIG. 8 illustrates a coagulation treatment device which is an example of the embodiment of the present invention.

A coagulation treatment device 201 illustrated in FIG. 8 is provided with a coagulation reaction tank 202, a solid-liquid separation tank 203, a sampling device 204, a flocculant adding device 206, and a treatment tank 207. In addition, the coagulation treatment device 201 illustrated in FIG. 8 is provided with a pressurized water supply part 60. Illustration of a raw water tank, a sludge tank, and a water to be treated reception tank are omitted.

In the coagulation treatment device 201, the coagulation reaction tank 202 and the solid-liquid separation tank 203 are arranged inside a sealed-type tank body 210 having substantially a rectangular parallelepiped shape. That is, the coagulation reaction tank 202 and the solid-liquid separation tank 203 are provided inside the tank body 210 by providing a partition wall 210a inside the tank body 210. In addition, moreover, the solid-liquid separation tank 203 is divided into two portions by a partition wall 210b. One serves as a mixing chamber 214, and the other serves as a floating separation chamber 215.

The coagulation reaction tank 202 is provided with a stirring device constituted of a stirring blade 212 and a motor 213. In addition, the coagulation reaction tank 202 is provided with the flocculant adding device 206 for adding a flocculant. This flocculant adding device 206 has the same constitution as the flocculant adding device 6 in the coagulation treatment device 1 illustrated in FIGS. 1 to 6. Moreover, the coagulation reaction tank 202 is constituted such that water to be treated is introduced from the upper part thereof. In addition, an opening part 210c is provided in the partition wall 210a defining the coagulation reaction tank 202 and the solid-liquid separation tank 203, and the coagulation reaction tank 202 and the solid-liquid separation tank 203 communicate with each other via this opening part 210c.

In addition, the water sending pipe 43 is connected to the coagulation reaction tank 202, and the sampling device 204 is provided at the tip of the water sending pipe 43. The sampling device 204 in FIG. 8 has the same constitution as the sampling device 4 in the coagulation treatment device 1 illustrated in FIGS. 1 to 6.

The solid-liquid separation tank 203 is divided into the mixing chamber 214 and the floating separation chamber 215 by the partition wall 210b. The mixing chamber 214 and the floating separation chamber 215 communicate with each other above the partition wall 210b. The mixing chamber 214 is disposed on the coagulation reaction tank 202 side and communicates with the coagulation reaction tank 202 via the opening part 210c. In addition, the floating separation chamber 215 is disposed at a position farther from the coagulation reaction tank 202 than the mixing chamber 214. That is, the mixing chamber 214 and the floating separation chamber 215 are provided in this order.

The pressurized water supply part 60 is connected to the mixing chamber 214 via an introduction pipe 83 and an electromagnetic valve 84. Pressurized water having gas pressurized and dissolved therein can be supplied to the mixing chamber 214 by the pressurized water supply part 60. Moreover, the mixing chamber 214 is provided with a polymer solution supply part 90. A polymer solution can be supplied to the mixing chamber 214 by the polymer solution supply part 90.

The pressurized water supply part 60 takes out water from a lower part of the floating separation chamber 215 via a piping 215a, causes outside air taken in by the pressurized water supply part 60 to be pressurized and dissolved in water taken out from the floating separation chamber 215 to make pressurized water, and supplies this pressurized water to a water conduit pipe 83.

The floating separation chamber 215 causes flocculation which has been coagulated due to a flocculant to float in an upper layer of water to be treated, thereby performing solid-liquid separation of flocculation and the water to be treated.

A flow channel L5 is provided between the floating separation chamber 215 and the treatment tank 207. Water to be treated after floatation separation is sent to the treatment tank 207 via the flow channel L5.

Next, operation of the coagulation treatment device 201 illustrated in FIG. 8 will be described.

Water to be treated is introduced into the coagulation reaction tank 202, and a flocculant is added thereto by the flocculant adding device 206. Thereafter, the water to be treated is retained inside the coagulation reaction tank 202 for a predetermined period of time while being stirred by the stirring blade 212. Accordingly, coagulation reaction proceeds. Thereafter, the water to be treated is sent to the mixing chamber 214.

In the mixing chamber 214, a polymer solution is supplied from the polymer solution supply part 90 to water to be treated which has been introduced into the mixing chamber 214. In this state, pressurized water manufactured by the pressurized water supply part 60 is supplied to the inside of the mixing chamber 214 via the introduction pipe 83 and the electromagnetic valve 84. The pressurized water includes gas which has been pressurized and dissolved, a pressurized state is resolved as the pressurized water is supplied to the mixing chamber 214, and the dissolved gas becomes fine bubbles. In this manner, fine bubbles are generated in water to be treated in the mixing chamber 214. These bubbles adhere to flocculation, and thus a buoyant force is applied to flocculation.

Water to be treated which has passed through the mixing chamber 214 is sent to the floating separation chamber 215, and flocculation is efficiently subjected to floatation separation. Floated flocculation is discharged by a scraping machine 230 such as a skimmer or a scraper.

On the other hand, water to be treated which has been partially collected through the water sending pipe 43 is continuously supplied to the sampling device 204. The retention part provided in the sampling device 204 is filled with the water to be treated. Further, the coagulation state of the water to be treated is measured by the coagulation sensor. Operation in the sampling device 204 is the same as operation of the sampling device 4 described above.

Measurement results from the coagulation sensor are sent to the control part of the flocculant adding device 206. In the control part, the adding amount of a flocculant is subjected to feedback control based on the coagulation state of water to be treated inside the coagulation reaction tank 202. In this manner, the measurement results of the coagulation state of water to be treated measured by the sampling device 204 are utilized for feedback control of the adding amount of a flocculant.

According to the coagulation treatment device 201 of the present example, the floatation separation-type coagulation treatment device 201 can be realized by providing the mixing chamber 214 and the floating separation chamber 215 in the solid-liquid separation tank 203 and providing the pressurized water supply part 60 for supplying pressurized water having gas pressurized and dissolved therein to the mixing chamber 214. In such a floatation separation-type coagulation treatment device 201, since the retention time of water to be treated is relatively long, responsiveness of addition control of a flocculant can be more significantly improved by providing the sampling device 204 according to the present invention.

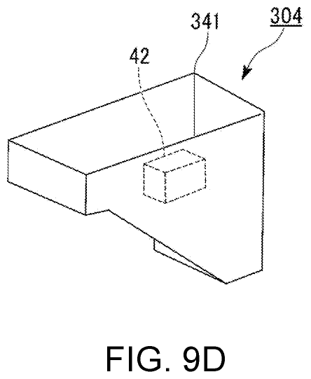

The sampling device of the present embodiment is not limited to those described above. Hereinafter, a second example of the sampling device will be described with reference to FIGS. 9A to 9D. In FIGS. 9A to 9D, the same reference signs are applied to the same constituent elements as the constituent elements illustrated in FIGS. 1 to 8, and description thereof will be omitted.

As illustrated in FIGS. 9A to 9D, a sampling device 304 of the second example is constituted of a sampling tank 341, the coagulation sensor 42, and the water sending pipe 43. The coagulation sensor 42 is installed inside the sampling tank 341. The water sending pipe 43 sends water to be treated from the coagulation reaction tank 2 to the sampling tank 341. In this sampling device 304, the coagulation state of water to be treated sent from the coagulation reaction tank 2 to the sampling tank 341 is measured by the coagulation sensor 42. Hereinafter, details of the sampling device 304 of the second example will be described.

The sampling tank 341 is a tank having an open upper part 341a. Water to be treated is introduced into the sampling tank 341 through the water sending pipe 43 disposed above the sampling tank 341. As illustrated in FIGS. 9A to 9D, the shape of the sampling tank 341 is a shape in which an open area gradually narrows from the upper part 341a toward a bottom part 341b. Such a shape in which an open area gradually narrows is realized by providing an inclined wall surface 341c in the sampling tank 341. Accordingly, when flocculation in water to be treated sediments and gathers at the bottom part 341b of the sampling tank 341, the flocculation is likely to be accumulated as sludge, and thus treatment of the flocculation can be easily performed.

In addition, the sampling tank 341 is provided with an overflow part 346 therein. The overflow part 346 is constituted of the inclined wall surface 341c, a flat surface 341d, and a drainage port 344. The flat surface 341d is connected to an upper end side of the inclined wall surface 341c. The drainage port 344 is provided on the flat surface 341d. The flat surface 341d is at a position higher than the inclined wall surface 341c and is at a position lower than the upper part 341a of the sampling tank 341. The drainage pipe 45 is connected to the drainage port 344. Due to such a constitution, when a water amount of water to be treated retained inside the sampling tank 341 increases, the height of the water level of the water to be treated reaches the height of the flat surface 341d, the water to be treated overflows the flat surface 341d, and the water to be treated is discharged to the outside of the sampling tank 341 via the drainage port 344 and the drainage pipe 45.

That is, water to be treated which has been sent from the coagulation reaction tank 2 to the sampling tank 341 through the water sending pipe 43 is temporarily stored inside the sampling tank 341. When water to be treated is continuously supplied even if the sampling tank 341 is completely filled with the water to be treated, the overflowed water to be treated flows from the drainage port 344 to the drainage pipe 45 over the height of the flat surface 341d constituting the overflow part 346 (water to be treated overflows).

In addition, a drain port 348 is provided at the bottom part 341b of the sampling tank 341. The drain pipe 47 is connected to the drain port 348. The drain valve 49 is provided in a middle portion of the drain pipe 47. The drain valve 49 is closed in an ordinary operation state and is opened in order to discharge sludge when sludge gathers at a bottom part of the sampling tank 341. The drain pipe 47 is connected to the sludge tank 9.

In the sampling device 304 of the present embodiment, it is preferable to set the water sending amount of water to be treated sent through the water sending pipe 43, the capacity of the sampling tank 341, and the drainage amount from the drainage port 344 such that the retention time of the water to be treated inside the sampling tank 341 is within a range of 1 to 30 minutes. Accordingly, the flow of the water to be treated inside the sampling tank 341 is made stable, and measurement of the coagulation state of the water to be treated by the coagulation sensor 42 is accurately performed. The reasons for limiting the retention time are as already described.

In addition, it is preferable that the flow rate per unit length of the width of a retention part 346 of the sampling tank 341 (V÷x (m²/hr), when the length of the width of the overflow part 346 is x (m) and the drainage amount from the drainage port 344 is V (m³/hr)) be 0.2 to 7.0 m²/hr or higher. The reasons for limiting the flow rate per unit length of the width of the retention part 346 (V÷x (m²/hr)) and an adjustment method therefor are as already described.

The coagulation sensor 42 is disposed inside the sampling tank 341. As illustrated in FIG. 9B, it is preferable that the coagulation sensor 42 be disposed below the position H3 at the water level height of water to be treated expected in the sampling tank 341 and above the position H4 at the height corresponding to half the water level height. In other words, as illustrated in FIG. 9B, the coagulation sensor 42 is disposed within the region R between the position H3 at the water level height and the position H4 at the height corresponding to half the water level height. Description of the positions H3 and H4 and the region R is as already described.

Measurement results of the coagulation state of water to be treated measured by the coagulation sensor 42 are sent to the control part 6b of the flocculant adding device 6 and utilized for feedback control of the adding amount of a flocculant.

The sampling device 304 illustrated in FIGS. 9A to 9D exhibits effects similar to those of the sampling device 4 illustrated in FIGS. 1 to 6. In addition, the sampling device 304 illustrated in FIGS. 9A to 9D can be favorably used in the coagulation treatment device illustrated in FIG. 7 or 8.

### Examples

Regarding Example 1, using the coagulation treatment device illustrated in FIG. 1, the part coagulation state of water to be treated partially collected from the coagulation reaction tank by the sampling device was measured, and coagulation treatment was performed under the following experimental conditions while the measurement results were utilized for feedback control.

In addition, regarding Comparative Example 1, in a state in which the water sending pipe of the sampling device illustrated in FIG. 1 was connected to the solid-liquid separation tank instead of the coagulation reaction tank, coagulation treatment was performed under the following experimental conditions while water to be treated partially collected from the solid-liquid separation tank was supplied to the sampling device and utilized for feedback control.

(Experimental Conditions of Example 1)
Target drainage: meat processing plant drainage (before biological treatment)
Solid-liquid separation: pressurization floatation method
Data collection period: 1 month
Turbidity in water to be treated: 100 (NTU) or lower

(Experimental Results of Example 1)
Drainage amount: 151,000 (m³/month)
Average value of raw water SS: 3,180 (mg/L)
Turbidity in treated water: 100 (NTU)>
Average addition rate of flocculant: 1,950 (mg/L)
Average addition rate of 25% NaOH: 700 (mg/L)

(Experimental Conditions of Comparative Example 1)
Target drainage: meat processing plant drainage (before biological treatment)
Solid-liquid separation: pressurization floatation method
Data collection period: 1 month
Turbidity in treated water: 150 (NTU) or lower

(Experimental Results of Comparative Example 1)
Drainage amount: 148,000 (m³/month)
Average value of raw water SS: 2,980 (mg/L)
Turbidity in treated water: 120 (NTU)>
Average addition rate of coagulant: 2,800 (mg/L)
Average addition rate of 25% NaOH: 900 (mg/L)

As is obvious from the foregoing results, in Example 1, the average addition rate of a flocculant was 1,950 (mg/L), which was significantly lower than the average addition rate of a coagulant 2,800 (mg/L) in Comparative Example 1. It is conceivable that this is because the coagulation state of water to be treated partially collected from the coagulation reaction tank was measured and the results thereof were subjected to feedback control in Example 1 so that the delay time of feedback control was shortened and the adding amount of a flocculant could be appropriately controlled compared to Comparative Example 1.

### INDUSTRIAL APPLICABILITY

According to the present invention, it is possible to provide a sampling device for a coagulation treatment device, a coagulation treatment device, and a water treatment method capable of improving responsiveness of addition control of a flocculant in the coagulation treatment device.

### REFERENCE SIGNS LIST

1, 201 Coagulation treatment device
2, 21, 202 Coagulation reaction tank
3, 203 Solid-liquid separation tank
4, 204, 304 Sampling device
5 Raw water tank
6 Flocculant adding device
6a Adding part
6b Control part
7 Treatment tank
8 Water to be treated reception tank
9 Sludge tank
21 Coagulation reaction tank
21c Introduction part
21d Drawing part
41, 341 Sampling tank
41A Drainage channel
41B Retention part
42 Coagulation sensor
43 Water sending pipe
44, 344 Drainage port
45 Drainage pipe
46, 346 Overflow part
46A Partition plate (overflow part)
46a Upper end of partition plate
341c Inclined wall surface (overflow part)
341d Flat surface (overflow part)
47 Drain pipe
48, 348 Drain port
49 Drain valve
60 Pressurized water supply part
214 Mixing chamber
215 Floating separation chamber
h1 Water level height
h2 Height corresponding to half water level height
H0 Reference position
H3 Position of water level height
H4 Position of height corresponding to half water level height

1. A sampling device for a coagulation treatment device including at least a sealed-type coagulation reaction tank into which water to be treated having a flocculant added thereto is introduced, and a solid-liquid separation tank into which the water to be treated drawn from the coagulation reaction tank is introduced, the sampling device comprising:
a sampling tank;
a coagulation sensor which is installed inside the sampling tank; and
a water sending pipe which sends a part of the water to be treated inside the coagulation reaction tank from the coagulation reaction tank of the coagulation treatment device to the sampling tank.

2. The sampling device for a coagulation treatment device according to claim 1,
wherein the coagulation sensor is disposed below a position at a water level height of the water to be treated expected in the sampling tank and above a position at a height corresponding to half the water level height.

3. The sampling device for a coagulation treatment device according to claim 2,
wherein an overflow part determining the water level height is provided inside the sampling tank, and
wherein the sampling tank is constituted such that water to be treated retained therein overflows the overflow part and is discharged to the outside of the sampling tank.

4. The sampling device for a coagulation treatment device according to claim 3,
wherein a water sending amount sent through the water sending pipe, a capacity of the sampling tank, and a drainage amount of the water to be treated from the sampling tank are set such that a retention time of the water to be treated inside the sampling tank is within a range of 1 to 30 minutes.

5. The sampling device for a coagulation treatment device according to claim 3,
wherein a drain valve is provided in a lower part of the sampling tank.

6. A coagulation treatment device comprising:
a sealed-type coagulation reaction tank into which water to be treated having a flocculant added thereto is introduced;
a solid-liquid separation tank into which the water to be treated drawn from the coagulation reaction tank is introduced; and
the sampling device according to claim 1.

7. The coagulation treatment device according to claim 6 further comprising:
a flocculant adding device which adds the flocculant to the water to be treated,
wherein the flocculant adding device is provided with an adding part which adds the flocculant to the water to be treated, and a control part which controls an adding amount of the flocculant added by the adding part based on measurement results of a coagulation sensor provided in the sampling device.

8. The coagulation treatment device according to claim 6,
wherein a mixing chamber and a floating separation chamber are provided in a flowing direction of the water to be treated in this order in the solid-liquid separation tank, and
wherein the solid-liquid separation tank is further provided with a pressurized water supply part supplying pressurized water having gas pressurized and dissolved therein to the mixing chamber.

9. A water treatment method comprising:
when coagulation separation treatment is performed with respect to water to be treated having a flocculant added thereto by introducing the water to be treated into a sealed-type coagulation reaction tank and then introducing the water to be treated drawn from the coagulation reaction tank to a solid-liquid separation tank,
a step of sending a part of water to be treated inside the coagulation reaction tank from the coagulation reaction tank toward a sampling tank;
a measurement step of measuring a coagulation state of the water to be treated using a coagulation sensor while separating flocculation in the water to be treated inside the sampling tank; and
a control step of performing feedback control of an adding amount of a flocculant to the water to be treated based on the coagulation state of water to be treated measured in the measurement step.

10. The water treatment method according to claim 9,
wherein the sampling tank is provided with an overflow part determining a water level height,
wherein the sampling tank is constituted such that water to be treated retained therein overflows the overflow part and is discharged to the outside, and
wherein a retention time of the water to be treated inside the sampling tank in the measurement step is adjusted to within a range of 1 to 30 minutes.
